(19) United States
(12) Patent Application Publication
(10) Pub. No.: US 2017/0090910 A1
(43) Pub. Date: Mar. 30, 2017

(54) MOBILE DEVICE APPLICATION INSTALLATION WITH PERFORMANCE ENHANCEMENT

(71) Applicant: International Business Machines Corporation, Armonk, NY (US)

(72) Inventors: Lisa Seacat DeLuca, Baltimore, MD (US); Jonathan J. Lidaka, Raleigh, NC (US); Aaron J. Quirk, Cary, NC (US)

(21) Appl. No.: 14/868,711

(22) Filed: Sep. 29, 2015

(51) Int. Cl. G06F 9/445; H04L 29/08; G06F 17/30

(52) U.S. Cl. CPC G06F 8/665; G06F 17/30203; G06F 8/61; G06F 17/30132; H04L 67/06; H04L 67/34

(57) ABSTRACT

In some aspects, a method for incorporating mobile content into an application may include retrieving, from a remote file server, application information and static cache data, incorporating the application information and the static cache data into the application information into an application binary, and validating the static cache data using cache version information, where validating may include determining whether a previous version of the static cache data exists on the mobile device, comparing the previous version of the static cache data with cache version information located on a remote server, and selectively retrieving an updated version of the static cache data from the remote server based on the cache version information, and incorporating the application binary into the application using the validated static cache data.

### BACKGROUND

The present disclosure relates to mobile device application installation, and more specifically, to mobile device application installation with performance enhancement.

Users of modern mobile device applications may form an immediate and lasting impression of the mobile application (app) based the first moments of loading the app on their device and launching the program. Users may uninstall an application very quickly after the installation if the initial operation of the app is slow-loading or cumbersome. The initial launch speed is often affected by program architecture.

Some mobile applications may use a hybrid web-based program architecture, where portions of the program are stored on the mobile device, and other portions of the program are stored remotely on a file server. Using this topology, the user installs the application on their device, but the program may only locally include a wrapper that launches a website through the program interface. In some instances, some or all of the Hypertext Markup Language (HTML) files, JavaScript files, and cascading style sheets (CSS) are received from a file server on demand, across a data connection extending between the mobile device and the remote server. Remotely accessing the execution files may delay the initial launch. Receiving the initial execution files across the mobile network may be slow due to system latency (the time from the client's request to the time receiving the first bit), data connection constraints, remote server speed, and other factors. The negative user experience often causes the mobile app user to either uninstall the application or never open the app again.

### SUMMARY

According to some embodiments, a method for incorporating mobile content into an application on a mobile device is described. The method may include retrieving, from a remote file server, application information and static cache data, incorporating the application information and the static cache data into the application information into an application binary, and validating the static cache data using cache version information, where validating may include determining whether a previous version of the static cache data exists on the mobile device, comparing the previous version of the static cache data with cache version information located on a remote server, and selectively retrieving an updated version of the static cache data from the remote server based on the cache version information, and incorporating the application binary into the application using the validated static cache data.

According other embodiments, device for installing an application is described. The device can include a processor configured to retrieve, from a remote file server, application information and static cache data, incorporate the application information and the static cache data into the application information into an application binary, determine whether a previous version of the static cache data exists on the mobile device, compare the previous version of the static cache data with cache version information located on a remote server, selectively retrieve an updated version of the static cache data from the remote server based on the cache version information, validate the static cache data using the cache version information, and incorporate the application binary into the application using the validated static cache data.

Embodiments may also include a non-transitory computer-readable storage medium. The computer-readable storage medium may store a computer program product executable to perform a method. The method may include retrieving, from a remote file server, application information and static cache data, incorporating the application information and the static cache data into the application information into an application binary, and validating the static cache data using cache version information, where validating may include determining whether a previous version of the static cache data exists on the mobile device, comparing the previous version of the static cache data with cache version information located on a remote server, and selectively retrieving an updated version of the static cache data from the remote server based on the cache version information, and incorporating the application binary into the application using the validated static cache data.

According to other embodiments, a system for installing a program on a mobile device is described. The system may include a remote file server operatively connected to a mobile device. The mobile device may include a processor configured to transmit, to the remote file server, a request for application information and static cache data, receive and install the application information and static cache data responsive to the request, validate the static cache data using cache version information, and execute the installed application information using the validated static cache data. The file server may include a processor configured to transmit the application information and the static cache data to the mobile device responsive to the request from the mobile device, and transmit the cache version information to the mobile device responsive to a validation request.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a block diagram of a computer system for use in practicing the teachings herein;

FIG. 2 depicts a system for performing a method for mobile device application installation with performance enhancement in accordance with an exemplary embodiment;

FIG. 3 depicts a flow diagram of a method for mobile device application installation with performance enhancement in accordance with an exemplary embodiment;

FIG. 4 depicts a flow diagram of a method for validating static cache data in accordance with an exemplary embodiment; and

FIG. 5 depicts a flow diagram of a method for selectively retrieving an updated version of cache data in accordance with an exemplary embodiment.

### DETAILED DESCRIPTION

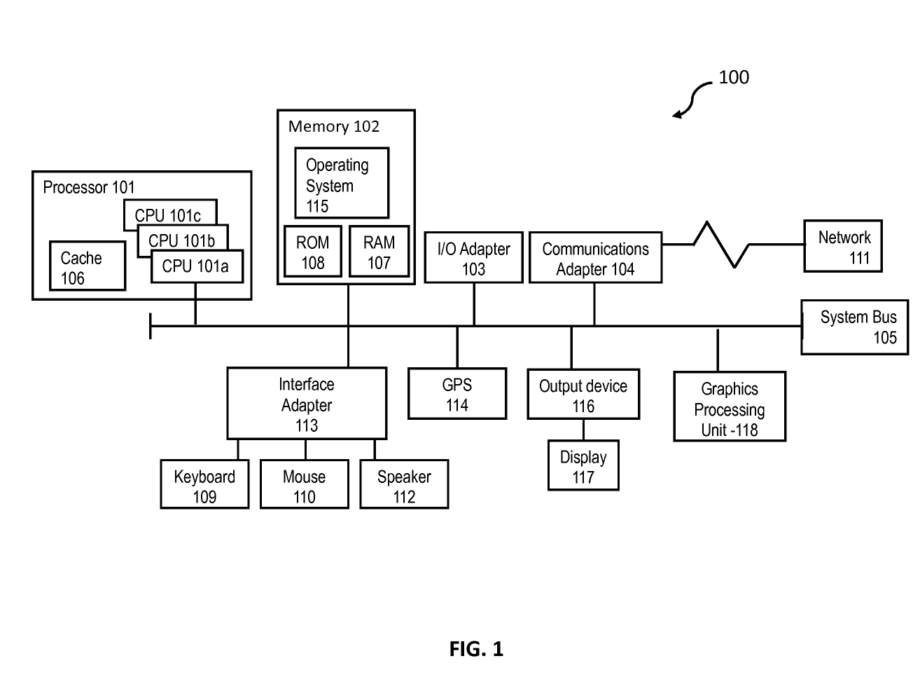

FIG. 1 illustrates a block diagram of a computer system 100 (hereafter “computer 100”) for use in practicing the embodiments described herein. The methods described herein can be implemented in hardware, software (e.g., firmware), or a combination thereof. In an exemplary embodiment, the methods described herein are implemented in hardware, and may be part of the microprocessor of a special or general-purpose digital computer, such as a personal computer, workstation, minicomputer, or mainframe computer. Computer 100 therefore can embody a general-purpose computer. In another exemplary embodiment, the methods described herein are implemented as part of a mobile device, such as, for example, a mobile phone, a personal data assistant (PDA), a tablet computer, etc.

In an exemplary embodiment, in terms of hardware architecture, as shown in FIG. 1, the computer 100 includes processor 101. Computer 100 also includes memory 102 coupled to processor 101, and one or more input and/or output (I/O) adaptors 103, that may be communicatively coupled via a local system bus 105. Memory 102 may be operatively coupled to one or more internal or external memory devices 109. Communications adaptor 104 may be operatively connect computer 100 to one or more networks 111. System bus 105 may also connect one or more user interfaces via interface adaptor 112. Interface adaptor 112 may connect a plurality of user interfaces to computer 100 including, for example, keyboard 109, mouse 110, speaker 111, etc. System bus 105 may also connect display adaptor 116 and display 117 to processor 101. Processor 101 may also be operatively connected to graphical processing unit 118.

Processor 101 is a hardware device for executing hardware instructions or software, particularly that stored in a non-transitory computer-readable memory (e.g., memory 102). Processor 101 can be any custom made or commercially available processor, a central processing unit (CPU), a plurality of CPUs, for example, CPU 101a-101c, an auxiliary processor among several other processors associated with the computer 101, a semiconductor based microprocessor (in the form of a microchip or chip set), a macroprocessor, or generally any device for executing instructions. Processor 101 can include a memory cache 106, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 106 may be organized as a hierarchy of more cache levels (L1, L2, etc.).

Memory 102 can include random access memory (RAM) 107 and read only memory (ROM) 108. RAM 107 can be any one or combination of volatile memory elements (e.g., DRAM, SRAM, SDRAM, etc.). ROM 108 can include any one or more nonvolatile memory elements (e.g., erasable programmable read only memory (EPROM), flash memory, electronically erasable programmable read only memory (EEPROM), programmable read only memory (PROM), tape, compact disc read only memory (CD-ROM), disk, cartridge, cassette or the like, etc.). Moreover, memory 102 may incorporate electronic, magnetic, optical, and/or other types of non-transitory computer-readable storage media. Note that the memory 102 can have a distributed architecture, where various components are situated remote from one another, but can be accessed by the processor 101.

The instructions in memory 102 may include one or more separate programs, each of which comprises an ordered listing of computer-executable instructions for implementing logical functions. In the example of FIG. 1, the instructions in memory 102 may include a suitable operating system 113. Operating system 110 can control the execution of other computer programs and provides scheduling, input-output control, file and data management, memory management, and communication control and related services.

Input/output adaptor 103 can be, for example but not limited to, one or more buses or other wired or wireless connections, as is known in the art. The input/output adaptor 103 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

Interface adaptor 112 may be configured to operatively connect one or more I/O devices to computer 100. For example, interface adaptor 112 may connect a conventional keyboard 109 and mouse 110. Other output devices, e.g., speaker 111 may be operatively connected to interface adaptor 112. Other output devices may also be included, although not shown. For example, devices may include but are not limited to a printer, a scanner, microphone, and/or the like. Finally, the I/O devices connectable to interface adaptor 112 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like.

Computer 100 can further include display adaptor 116 coupled to one or more displays 117. In an exemplary embodiment, computer 100 can further include communications adaptor 104 for coupling to a network 111.

Network 111 can be an IP-based network for communication between computer 100 and any external device. Network 111 transmits and receives data between computer 100 and external systems. In an exemplary embodiment, network 111 can be a managed IP network administered by a service provider. Network 111 may be implemented in a wireless fashion, e.g., using wireless protocols and technologies, such as WiFi, WiMax, etc. Network 111 can also be a packet-switched network such as a local area network, wide area network, metropolitan area network, Internet network, or other similar type of network environment. The network 111 may be a fixed wireless network, a wireless local area network (LAN), a wireless wide area network (WAN) a personal area network (PAN), a virtual private network (VPN), intranet or other suitable network system.

If computer 100 is a PC, workstation, laptop, tablet computer and/or the like, the instructions in the memory 102 may further include a basic input output system (BIOS) (omitted for simplicity). The BIOS is a set of essential routines that initialize and test hardware at startup, start operating system 113, and support the transfer of data among the operatively connected hardware devices. The BIOS is stored in ROM 108 so that the BIOS can be executed when computer 100 is activated. When computer 100 is in operation, processor 101 may be configured to execute instructions stored within the memory 102, to communicate data to and from the memory 102, and to generally control operations of the computer 100 pursuant to the instructions.

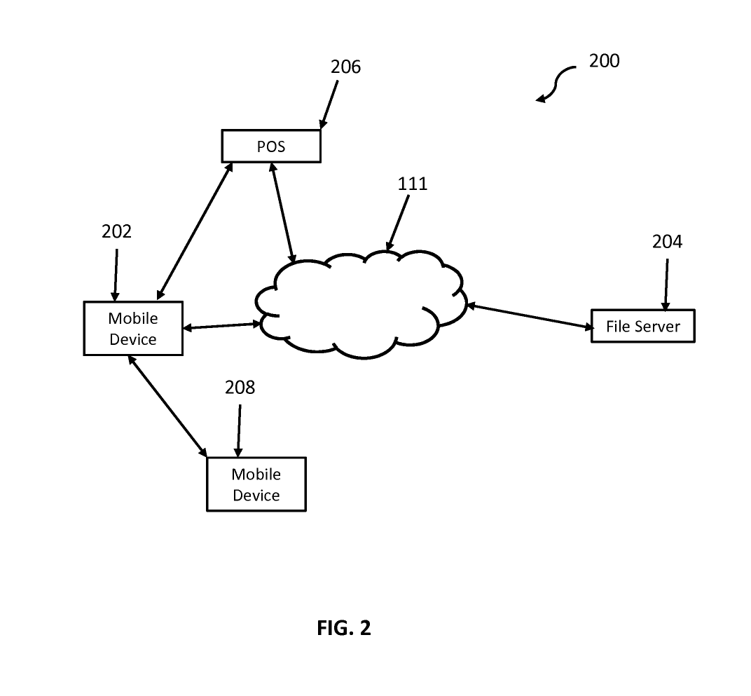

Referring now to FIG. 2, a system 200 for performing a method for mobile device application installation with performance enhancement is depicted. System 200 may include one or more mobile devices 202. Mobile device 202 may communicate with one or more application servers 204 via network 111. Mobile device 202 may be any of a plurality of mobile devices such as, for example, cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 100 illustrated in FIG. 1 may itself embody one or more of these devices. Mobile device 202 may be configured to communicate with one or more remote file servers (e.g., file server 204) via network 111.

File server 204 may embody a general purpose computer such as, for example, computer system 100. File server 204 may include static content files that, when executed on mobile device 202, cause mobile device 202 to operate in a particular way. For example, file server 204 may include support information for administering hybrid applications in one or more operatively connected mobile devices such as mobile device 202.

A hybrid application is a program that combines elements of locally-stored applications (on a remote device e.g., mobile device 202), and web-based applications (such as, for example, application data stored on a remote file server 206). Hybrid applications are generally available via multiple computing platforms distributed across networks (e.g., the Internet), and made available through an Internet browser, and/or a wrapper (shell program) on the client device.

In a hybrid program, according to some embodiments, the shell program may not operate independent of the information received across the network. For example, mobile device 202 may receive a user input indicative of a request to install a particular application on the mobile device. Mobile device 202 may transmit the request to file server 204. The application installation request may include a general request for installation of one or more programs. File server 204 may receive the request, determine one or more appropriate files to push to mobile device 202 via network 111, and provide the one or more files to mobile device 202 via network 111.

In some aspects, mobile device 202 may have saved upon it a portion of the desired program installed on the device already, and request the remaining files, data, etc., from file server 204 at the time of executing the installation request. For example, if an application requires files A, B, C, and D to operate. Mobile device 202 may send a general request for a mobile application installation to file server 204. The general request may include information indicative of the portion(s) of the requested program already present on mobile device 202. For example, mobile device 202 may already have files A and B installed in its memory, which may be a wrapper or shell for the application. The general request may include a specific request that files C and D be forwarded to mobile device 202.

The initial installation and launch of an application may include, as in this example, transmitting the request from mobile device 202 to file server 204, routing the request via network 111, receiving TCP acknowledgements from file server 204, transferring the requested files from file server 204 to mobile device 202, installing the files, and finally launching the application. The initial application launch may be delayed due to various factors affecting the transfer speed. According to some embodiments, application installation with enhanced performance may be advantageous to maximize the possibility of a positive user experience.

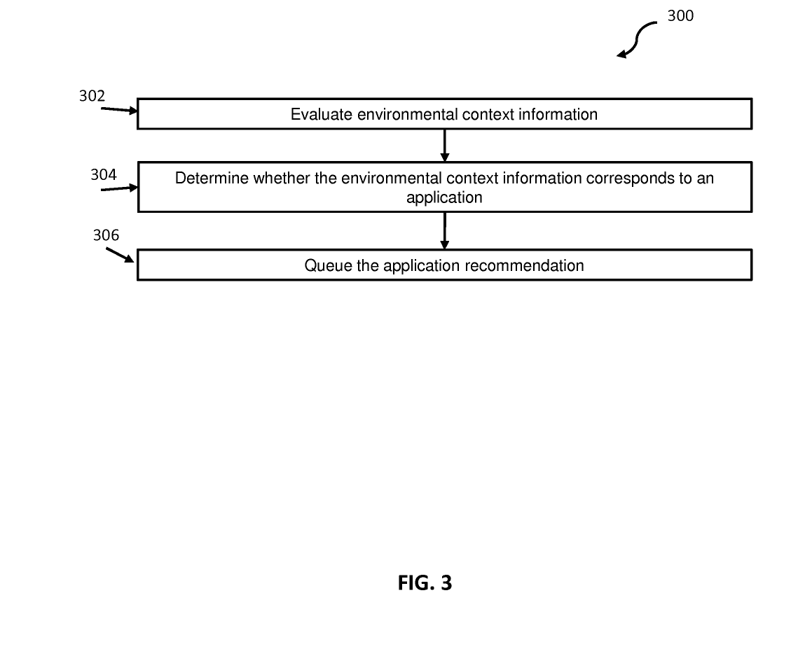

Referring now to FIG. 3, a method for mobile device application installation with performance enhancement is considered. According some embodiments, mobile device 202 may receive user input indicative of a command to install an application. Responsive to the user input, mobile device 202 may retrieve application information and cache data from file server 204.

In some aspects, retrieving application and static cache data may include determining specific information needed for proper installation and operation of the mobile application. Mobile device 202 may make this determination by accessing a database of program data stored either locally on mobile device 202, remotely on another server (e.g., file server 204), or both. For example, program data may be a lookup table (not shown) indicative of the files necessary for operative installation of the program on mobile device 202. The lookup table may be stored on server 204 and transferred to mobile device 202 after receiving an installation request from the device.

According to some embodiments, program data may include any information useful and/or necessary for successful installation and operation of the requested mobile application on mobile device 202. For example, program information may include information such as (but not limited to) file version information, file version day and time information, file location, alternate file locations, etc. Mobile device 202 may access program data to determine what particular files are needed for an updated and operable installation of the requested program, and to determine the location of those files.

According to some embodiments, mobile device 202 may retrieve application information and static cache data from remote file server 204. In some aspects, static cache data may include program files currently installed or otherwise present on the computer memory of mobile device 202 that may be necessary for installing and running the requested program. For example, mobile device 202 may receive a user request to install an application. Mobile device 202 may identify, via processor 101, which of the files needed for installation and operation of the program are currently present in the cache memory 106 of mobile device 202. Alternatively, static cache information may be saved in memory 102. Mobile device may retrieve application information from file server 204 by accessing program information, identifying needed files, and transmitting the request to server 204 for application information and static cache data.

According to some embodiments, application information may include general installation files. According to some embodiments, application information may include reference tags indicative of program files and/or elements that should be included in pre-population of cache 106 prior to the first launch of the program. For example, application information may indicate whether a file is necessary for operation, a remote location for accessing the file, file update information, file version information, date and time information, etc. Mobile device 202 may retrieve application information, and use the information to determine the most efficient way to launch the program with the smallest delay.

Referring again to FIG. 3, mobile device 202 may retrieve application information and static cache data from remote file server 204, as shown at block 302. Mobile device 202 may install the application information and the static cache data, as shown at block 304, and validate the static cache data using the cache version information. By validating the static cache data, mobile device 202 may ensure that the most current versions of the application files are installed.

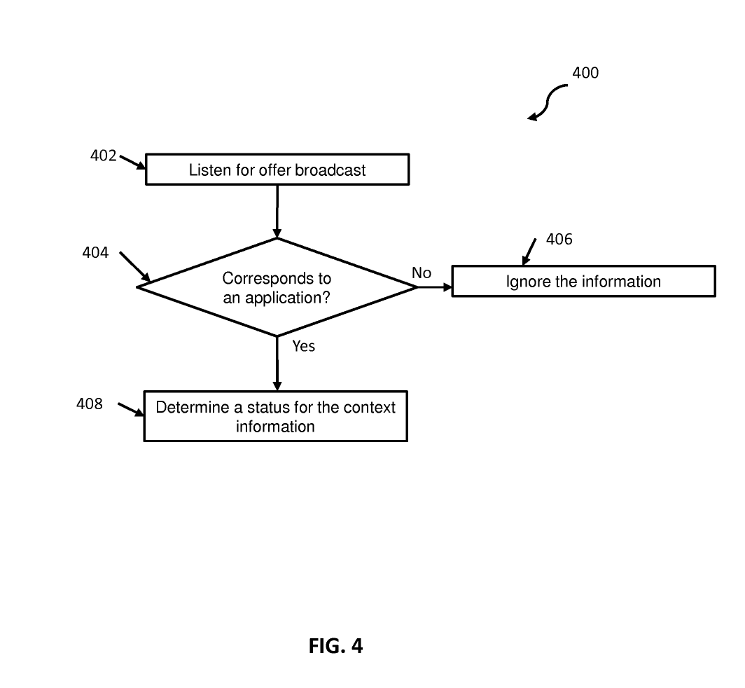

FIG. 4 depicts a method 400 for validating static cache data, according to some embodiments. As illustrated at decision block 402, mobile device 202 may determine, via processor 101, whether a previous version of the static cache data exists on the device. According to some embodiments, if a previous version of static cache data exists on mobile device 202, mobile device 202 may access program data located either remotely or on the local device. In some aspects, mobile device 202 may compare the previous version of the cache data to the cache data version located on remote file server 204, as shown at block 404. Mobile device 202 may make this comparison using program data indicative of the most current applicable program files on server 204.

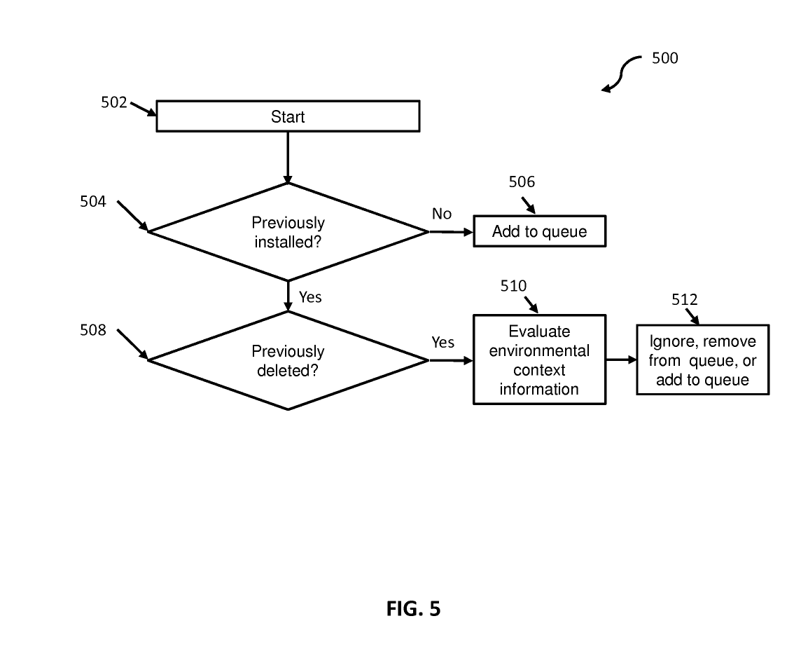

According to some embodiments, at block 408, mobile device 202 may selectively retrieve one or more updated of static cache data, and save the updated cache data to a cache memory of mobile device 202 (e.g., cache memory 106). FIG. 5 depicts an exemplary method for selectively retrieving an updated version of cache data.

Referring briefly to FIG. 5, if mobile device 202 determines that previous versions of static cache information are outdated, mobile device 202 may minimize the installation time by determining which cache data files are outdated, as shown at block 502. Mobile device 202 may make the determination based, in part, on program data received from file server 204. Accordingly, as shown at block 504 mobile device 202 may transmit a request for updated versions of particular static cache files. File server 204 may receive the request for the specific files from mobile device 202, and transmit the files via network 111. In some aspects, mobile device 202 may receive the transmission from mobile server 204 and replace the outdated cache data files on cache memory 106 with the updated versions, as shown at block 506.

Referring again to FIG. 4, according to some embodiments, at decision block 402 mobile device 202 may determine that a previous version of static cache data is located on the device, and that the previous version is current with the version located on remote file server 204. At block 410 mobile device 202 may use the existing static cache data, execute the remaining installation operations.

Referring again to FIG. 3, after validating the static cache data using the cache version information, as shown at block 306, mobile device 202 may execute the installed application information using the validated static cache data, as shown at block 308.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for incorporating mobile content into an application on a mobile device comprising:
retrieving, from a remote file server, application information and static cache data;
incorporating the application information and the static cache data into the application information into an application binary;
validating the static cache data using cache version information, wherein validating comprises:
determining whether a previous version of the static cache data exists on the mobile device;
comparing the previous version of the static cache data with cache version information located on a remote server, and
selectively retrieving an updated version of the static cache data from the remote server based on the cache version information; and
incorporating the application binary into the application using the validated static cache data.

2. The method of claim 1, wherein selectively retrieving the updated version of the static cache data comprises:
determining, from the comparison of the previous version of the static cache data with the cache version information, any files from a plurality of application files that are outdated, and
retrieving the updated version of the static cache data, wherein the updated version comprises only a corresponding one of the updated versions of the outdated files.

3. The method of claim 1, wherein incorporating the application binary comprises saving the installation information to a local memory of the mobile device, and saving the static cache data to a cache memory of the mobile device.

4. The method of claim 3, wherein the updated version of the static cache data is retrieved from the remote server responsive to determining that the previous version of the static cache data exists on the mobile device.

5. The method of claim 1, further comprising modifying the static cache data to conform to a local cache specification.

6. The method of claim 1, further comprising periodically monitoring the remote file server to detect whether the static cache information has changed.

7. The method of claim 6, further comprising:
responsive to determining that the cache information has changed, updating the application binary.

8. A device for installing an application, the device comprising:
a processor configured to:
retrieve, from a remote file server, application information and static cache data;
incorporate the application information and the static cache data into the application information into an application binary;
determine whether a previous version of the static cache data exists on the mobile device;
compare the previous version of the static cache data with cache version information located on a remote server,
selectively retrieve an updated version of the static cache data from the remote server based on the cache version information,
validate the static cache data using the cache version information; and
incorporate the application binary into the application using the validated static cache data.

9. The device of claim 8, wherein the processor is further configured to determine, from the comparison of the previous version of the static cache data with the cache version information, any files from a plurality of application files that are outdated, and
retrieve the updated version of the static cache data, wherein the updated version comprises only a corresponding one of the updated versions of the outdated files.

10. The device of claim 8, wherein incorporating the application binary comprises saving the installation information to a local memory of the mobile device, and saving the static cache data to a cache memory of the mobile device.

11. The device of claim 10, wherein the processor is configured to retrieve the updated version of the static cache data from the remote server responsive to determining that the previous version of the static cache data exists on the mobile device.

12. The device of claim 8, wherein the processor is further configured to modify the static cache data to conform to a local cache specification.

13. The device of claim 8, wherein the processor is further configured to periodically monitor the remote file server to detect whether the static cache information has changed.

14. The device of claim 13, wherein the processor is further comprised to
update the application binary responsive to determining that the cache information has changed.

15. A non-transitory computer-readable storage medium storing a computer program product executable to perform a method, the method including:
retrieve, from a remote file server, application information and static cache data;
incorporate the application information and the static cache data into the application information into an application binary;
determine whether a previous version of the static cache data exists on the mobile device;
compare the previous version of the static cache data with cache version information located on a remote server,
selectively retrieve an updated version of the static cache data from the remote server based on the cache version information,
validate the static cache data using the cache version information; and
incorporate the application binary into the application using the validated static cache data.

16. The non-transitory computer-readable storage medium of claim 15, wherein selectively retrieving the updated version of the static cache data comprises:
determining, from the comparison of the previous version of the static cache data with the cache version information, any files from a plurality of application files that are outdated, and
retrieving the updated version of the static cache data, wherein the updated version comprises only a corresponding one of the updated versions of the outdated files.

17. The non-transitory computer-readable storage medium of claim 16, wherein incorporating the application binary comprises saving the installation information to a local memory of the mobile device, and saving the static cache data to a cache memory of the mobile device.

18. The non-transitory computer-readable storage medium of claim 15, further comprising modifying the static cache data to conform to a local cache specification.

19. The non-transitory computer-readable storage medium of claim 13, further comprising periodically monitoring the remote file server to detect whether the static cache information has changed.

20. The non-transitory computer-readable storage medium of claim 19, further comprising:
responsive to determining that the cache information has changed, updating the application binary.
